(19) United States
(12) Patent Application Publication
(10) Pub. No.: US 2008/0059015 A1
(43) Pub. Date: Mar. 6, 2008

(54) SOFTWARE ARCHITECTURE FOR HIGH-SPEED TRAVERSAL OF PRESCRIBED ROUTES

(76) Inventors: William L. Whittaker, Pittsburgh, PA (US); Chris Urmson, Pittsburgh, PA (US); Kevin Peterson, Pittsburgh, PA (US); Vanessa Hodge, San Francisco, CA (US); Jarrod Snider, Pittsburgh, PA (US)

Correspondence Address: REED SMITH LLP, P.O. BOX 488, PITTSBURGH, PA, 15230-0488, US

(21) Appl. No.: 11/761,362

(22) Filed: Jun. 11, 2007

Related U.S. Application Data
(60) Provisional application No. 60/812,693, filed on Jun. 9, 2006.

(51) Int. Cl. G05D 1/00

(52) U.S. Cl. 701/23; 901/1

(57) ABSTRACT

Systems, methods, and apparatuses for high-speed navigation. The present invention preferably encompasses systems, methods, and apparatuses that provide for autonomous high-speed navigation of terrain by an un-manned robot. By preferably employing a pre-planned route, path, and speed; extensive sensor-based information collection about the local environment; and information about vehicle pose, the robots of the present invention evaluate the relative cost of various potential paths and thus arrive at a path to traverse the environment. The information collection about the local environment allows the robot to evaluate terrain and to identify any obstacles that may be encountered. The robots of the present invention thus employ map-based data fusion in which sensor information is incorporated into a cost map, which is preferably a rectilinear grid aligned with the world coordinate system and is centered on the vehicle. The cost map is a specific map type that represents the traversability of a particular environmental area using a numeric value. The planned path and route provide information that further allows the robot to orient sensors to preferentially scan the areas of the environment where the robot will likely travel, thereby reducing the computational load placed onto the system. The computational ability of the system is further improved by using map-based syntax between various data processing modules of the present invention. By using a common set of carefully defined data types as syntax for communication, it is possible to identify new features for either path or map processing quickly and efficiently.

### CROSS-REFERENCE TO RELATED APPLICATION

This application claims the benefit under 35 U.S.C. § 119(e) of the earlier filing date of U.S. Provisional Application Ser. No. 60/812,693 filed on Jun. 9, 2006, which is hereby incorporated by reference.

### BACKGROUND OF THE INVENTION

1. Field of the Invention

The present invention relates to methods, systems, and apparatuses for the autonomous navigation of terrain by a robot.

2. Description of the Background

Autonomously navigating an environment at high-speeds for long distances is a challenge that has long confronted the robotic field. One of the fundamental aspects of the problem is how a robot should quickly identify obstacles, undesirable terrain, and preferred paths while at the same time maintaining a high speed. A high-speed robot would also preferably keep track of its location and pose, i.e. robot orientation, speed, etc. A robot traveling at high speed would need to make these perceptions and decisions about vehicle path and speed rapidly so as to avoid any obstacles or terrain that may result in catastrophic failure of the robot.

The utility of an autonomously navigating robot in military situations is clear; autonomous vehicles may travel through environments that are dangerous for humans. In addition, autonomously navigating robots may be used non-militarily to investigate inhospitable environments, such as other planets. Finally, autonomously navigating robots may be used to perform a variety of tasks, including, but not limited to farming or earth moving.

Thus, there has been a long-standing need in the robotic field for methods, systems, and apparatuses that enable a robot to navigate an environment at high speeds in a safe and timely manner. The methods, systems, and apparatuses would preferably allow the robot to make rapid determinations of terrain, robot pose, and potential obstacles to generate an appropriate path for navigating an environment.

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1 shows input maps and a fused composite map;

FIG. 2 depicts the fields of view for sensors in an embodiment of the present invention;

FIG. 3 displays the location of sensors on an embodiment of the present invention;

FIG. 4 is an example of obstacle detection performed by an embodiment of the present invention;

FIG. 5 is a depiction of the operation of a classifier within the context of the present invention;

FIG. 6 depicts the output of a classifier;

FIG. 7 shows a schematic of the overall architecture of the navigation software for a presently preferred embodiment of the present invention;

FIG. 8 displays a cost map used within the context of the present invention; and

FIG. 9 depicts a path-centric map used within the context of the present inventions.

### SUMMARY OF THE INVENTION

The present invention preferably encompasses systems, methods, and apparatuses that provide for autonomous high-speed navigation of terrain by an un-manned robot. By preferably employing a pre-planned route, path, and speed; extensive sensor-based information collection about the local environment; and information about vehicle pose, the robots of the present invention evaluate the relative cost of various potential paths and thus arrive at a path to traverse the environment. The information collection about the local environment allows the robot to evaluate terrain and to identify any obstacles that may be encountered. The robots of the present invention thus employ map-based data fusion in which sensor information is incorporated into a cost map, which is preferably a rectilinear grid aligned with the world coordinate system and is centered on the vehicle. The cost map is a specific map type that represents the traversability of a particular environmental area using a numeric value.

Hereby fully incorporated by reference, as if set forth in their entirety herein, are the copending and commonly assigned U.S. patent applications filed on even date herewith entitled “SYSTEM AND METHOD FOR AUTONOMOUSLY CONVOYING VEHICLES” (inventors: Urmson, Whittaker, and Peterson) and “OBSTACLE DETECTION ARRANGEMENTS IN AND FOR AUTONOMOUS VEHICLES” (inventors: Whittaker, Johnston, and Ziglar). These related applications disclose systems, arrangements and processes in the realm of autonomous vehicles that may be freely incorporable with one or more embodiments of the present invention and/or represent one or more contextual environments in which at least one embodiment of the present invention may be employed. These related applications may also readily be relied upon for a better understanding of basic technological concepts relating the embodiments of the present invention.

The planned path and route provide information that further allows the robot to orient sensors to preferentially scan the areas of the environment where the robot will likely travel, thereby reducing the computational load placed onto the system. The computational ability of the system is further improved by using map-based syntax between various data processing modules of the present invention. By using a common set of carefully defined data types as syntax for communication, it is possible to identify new features for either path or map processing quickly and efficiently.

### DETAILED DESCRIPTION OF PREFERRED EMBODIMENTS OF THE PRESENT INVENTION

It is to be understood that the figures and descriptions of the present invention have been simplified to illustrate elements that are relevant for a clear understanding of the invention, while eliminating, for purposes of clarity, other elements that may be well known. The detailed description will be provided hereinbelow with reference to the attached drawings.

The present invention encompasses systems, methods, and apparatuses for the autonomous and high-speed navigation of terrain by an unmanned robot. The software architectures and computational structures of the present invention accomplish the rapid evaluation of terrain, obstacles, vehicle pose, and vehicle location to allow for the identification of a viable trajectory for navigation by the robot. The present invention accomplishes those goals by employing path-centric navigation structure. The present invention also preferably employs a perception system that employs laser- and RADAR-based scanning to identify objects in the environment. Further, the apparatuses of the present invention evaluate information from the scans and generate a map that represents the relative “traversal cost” of different portions of the environment. The robot then selects a path based on that cost quantification so as to navigate an environment efficiently and safely. The present invention preferably employs the path and cost map as syntax for communication between various data processing modules. By using a common set of carefully defined and strictly controlled data types as the syntax for communication, it is possible to quickly develop new settings for the robots navigation and to adapt the system to new types of semantic content as they are identified.

As used herein, “robot” refers to any electronically driven autonomous vehicle. The description of the present invention will be undertaken primarily with respect to robots that are autonomous automobiles that are particularly effective in traversing desert terrain. However, the use of that exemplary robot and environment in the description should not be construed as limiting. Indeed, the methods, systems, and apparatuses of the present invention may be implemented in a variety of vehicles and circumstances. For example, the present invention may be useful in developing navigation strategies for farming equipment, earth moving equipment, seaborne vehicles, and other vehicles that need to autonomously generate a path to navigate an environment.

The present invention addresses the problems associated with the navigation of a terrain by an unmanned vehicle. In fundamental terms, the task of unmanned, high-speed navigation by a robot involves the rapid development of a path for the vehicle to employ while traversing an environment. To navigate safely, a robot is preferably able to identify obstacles and plan a path to avoid those objects quickly. Further, the present invention preferably allows for the evaluation of terrain and robot pose to generate a path and speed that avoids rollover or sliding of the robot. At the same time, the path and speed preferably allow the robot to complete the prescribed path in a timely manner.

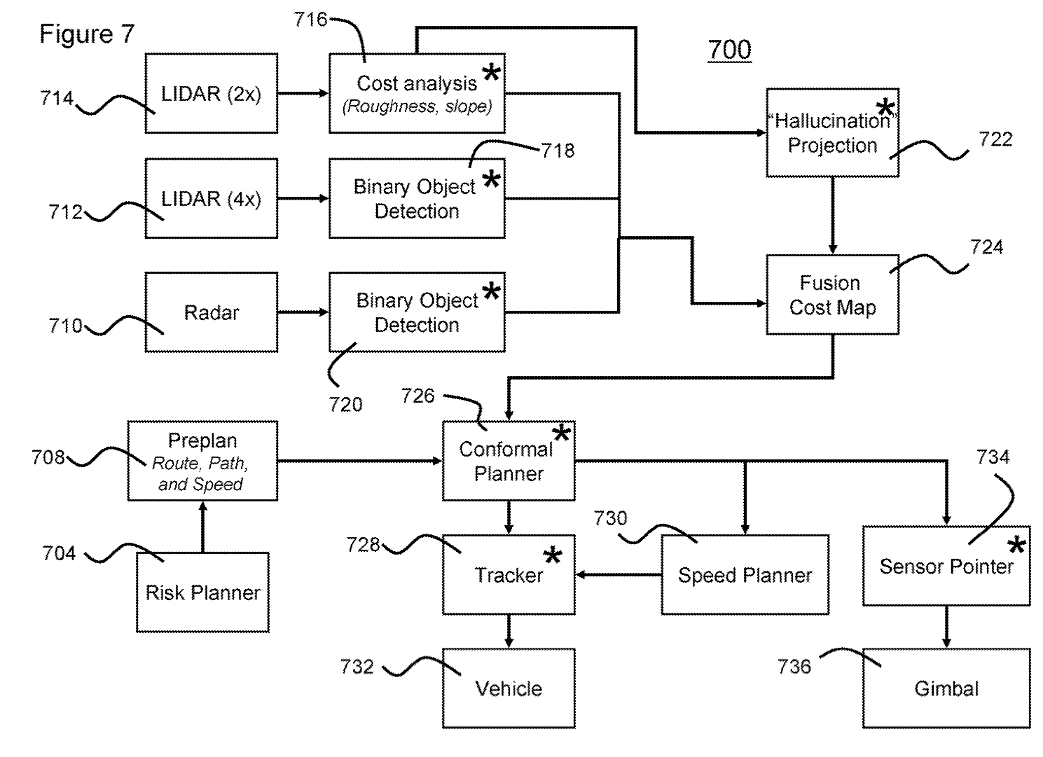

The present invention preferably employs a multi-step process as described herein to navigate an environment. Prior to the robot going into the field, a pre-planned route, path, and speed are established. Those pre-planned data are fused with information about the immediate environment of the robot obtained from the onboard sensors to develop a detailed cost map of the robot's environment. The fused map is used to develop a new path for the robot that is then implemented while the robot is in the field. The pre-planning process will be first described, followed by a discussion of the presently preferred sensors on the robot and how they are used to evaluate its environment. Finally, the navigational software (FIG. 7) that employs those two data sets will be discussed.

The pre-planning portion of the navigation systems of the present invention creates a pre-planned path, including its associated speed limits and estimated elapsed time, prior to the robot traversing a route. As used herein, “route” refers to an area within the environment within which the robot will navigate and corresponds roughly to the roads selected from a map in planning a trip. In contrast, as used herein “path” refers to the specific points that the robot pass through or plans to pass through. For example, the “path” would then correspond to the specific lane or part of the road on which the robot travels. The preplanning system of the present invention preferably provides critical input that allows the navigation system to make assumptions about the environment to be navigated. The pre-planning system initially may be provided with a series of waypoints that define a route to be traversed by the robot. In presently preferred embodiments, the waypoints are provided as GPS coordinates. The pre-planning system is also preferably provided with any hard speed limits that are implemented as part of the route. A prescribed path is interpolated between waypoints and in certain preferred embodiments, the path is generated using splines. The splines may then be adjusted by human editors to smooth tight-radius curves and to bias the path away from areas of high risk. The splines are then converted to tightly spaced waypoints (e.g. one meter distance between waypoints) that define a search area to be used by the robot.

The interpolation process preferably produces a prescribed path of curved splines from waypoint to waypoint defined by a series of control points and spline angle vectors. Human editors can alter these splines by shifting a series of spline control points, and spline angle vectors that adjust to specify the location and orientation of the path. The generated splines may be constrained to ensure continuity to prevent discontinuities in both the position and heading of a prescribed path. The human editing portion of path pre-planning helps to remove unnecessary curvature, which in turn helps robots drive more predictably. Low curvature paths can also be executed at higher speeds since lateral acceleration is directly related to the product of velocity and curvature Additionally, the prescribed path may define a route which is known to be somehow traversable. That attribute may be taken advantage of to increase planning speed and accuracy during traversal.

During pre-planning, a speed setting process specifies the target speeds for an autonomous vehicle given a target elapsed time to complete a pre-planned path. Speed setting is performed by assessing the risk for a given robot to traverse a section of terrain based on available information. An automated process then preferably uses a speed policy generated by combining the risk assessment with any speed limits imposed on the course to assign planned speeds to each waypoint in the path.

The risk estimation process discretizes risk into multiple levels in classifying terrain. In presently preferred embodiments, four risk levels are employed (dangerous, moderate, safe, and very safe). Each risk level maps to a range of safe robot driving speeds for that terrain. Risk may first be assigned regionally, over multiple kilometers at a time. This regional risk may be derived from satellite, over-flight, or other information. Once the entire route has risk assigned at a coarse level, a first order approximation of the ease/difficulty of that route, as well as an estimate of the overall elapsed time can be generated.

In addition to classifying risk at a macro level, risk is also assigned to local features of importance. This step characterizes and slows the planned vehicle speed for such difficulties as washouts, overpasses, underpasses, and gates. In this manner, the human editor provides a robot with a set of “pace notes”, similar to the information used by professional rally race drives. These details allow a robot to take advantage of prior knowledge of the world to slow preemptively, much as a human driver would slow down.

An automated process combines the risk assessment with a dynamics model of the robot and speed limits to generate a path that allows the robot to complete a route in a given elapsed time. In the first step of the automated process, each waypoint is preferably assigned the lesser of the speed limit and the dynamics-safe speed based on the terrain and expected vehicular stability properties. The resulting path is then filtered to provide reasonable acceleration and deceleration profiles to arrive at the fastest permissible path. Next, the speed policy generated during the risk assessment is applied to the waypoints and the speed at each waypoint is set to the minimum speed within the speed range for the assigned risk. Once again, the path is filtered to account for deceleration and acceleration. This path is used as the starting point for determining a path that will meet the desired elapsed time.

In certain preferred embodiments, the process by which the path is sped up is predicated on two assumptions. The first assumption is that the process of assigning path segments to risk levels has normalized risk. The second assumption is that a small linear increase in speed linearly increases risk within each level (i.e. increasing speed by 10% in safe terrain and increasing speed by 10% in slower, high risk terrain will result in the same overall risk increase). The speed ranges for each risk level are assigned to help maintain this assumption. Given these two assumptions, the algorithm to increase speed iteratively adjusts a speed scale factor which is applied to the speed for every point in the path. The speed at each waypoint is limited to the lower of the maximum permissible speed or the upper speed bound for the assigned risk level at the point. The iteration process is either terminated by achieving the desired elapsed time or by maximizing the possible speed at all points along the route. In the latter case, the algorithm reports that the desired elapsed time was not achieved.

Following the speed and path planning step, an error checking step ensures that the path and route are free from potentially fatal errors. The safety of the path and route may be evaluated in multiple manners including automated and human-based review. An automated inline verification system may be used during pre-planned path generation to provide human editors periodic updates of locations where the path being edited violates any constraints. The specific constraints preferably considered are: (1) exceeding of corridors boundaries, (2) path segments with radii tighter than a robot's turning radius, and (3) areas where the route is very narrow and warrants extra attention. Each of these potential problems is flagged for review by a human editor. These flags are then used as focal points for interpreting the path.

An automated external verification system may also be used to operate on the final output to the robot and to check heading changes, turning radius, speeds, and boundary violations. In addition, the verification process outputs warnings in areas where slope near the path is high or the corridor around the path is narrow. These warnings are preferably used to identify areas for the human editors where extra care should be used. The verification process also produces a number of strategic route statistics such as a speed histogram for time and distance, a slope histogram, and a path width histogram. These statistics are used in determining the target elapsed time for the route and in estimating the risk of the route. This process is repeated several times as the path detailing progresses until the route is deemed safe for the robots to use.

Editors review each segment multiple times to ensure the route final route is of high quality. While detailing a route, each segment preferably undergoes an initial review by editors which fixes major problems. The first review looks for any errors in the output of the automated planner, and attempts to identify areas of high risk for a robot, such as washouts. These high risk areas are then flagged, to be confirmed in a second review. A second review takes the output of the first review, and refines the route, confirming marked “flags” and adding additional “flags” for any high risk areas missed in the first review. The expectation is that after completion of the second review there will be no need for additional editing of the geometry of the route. In the 3^{rd} and 4^{th} reviews the main focus is to verify that all problems identified by the automated inline verification process have been cleared, as well as to confirm that any problems identified by the automated external verification algorithm are addressed.

The output from the preplanning process provides the navigation system with a route, a planned path, and planned speed limits for the robot. The pre-planned path and speed provide the robot with an outline to gracefully execute a course, using foreknowledge of the course to slow down for harsh terrain features. Even though the pre-planned path is useful in predicting and enabling high-speed navigation, the robot will encounter circumstances in the field that cannot be anticipated by pre-planning. For example, obstacles may be encountered along the route, thus forcing the robot to deviate from the pre-planned path and speed to avoid them. In addition, deviations in road location or vehicle localization may result in the pre-planned path being inappropriate. In some presently preferred embodiments, a network of routes—rather than a single path—may be employed. In such embodiments, if a leg of the route network is blocked or somehow other intraversable, then the robot selects another leg and continues along the path. The robot will be forced to alter the specific path that is followed during the navigation itself through the information obtained about the local environment during travel. While this information is integral to the success of the autonomous vehicle, the pre-planned route nonetheless provides the robot with valuable information. The pre-planned route specifically provides the robot with a limited space to search during navigation, thus reducing the complexity of the system and improving its tractability.

In order to reliably and safely navigate, the robot needs to collect information about the environment and its own pose (i.e. orientation, location, speed, etc.). In presently preferred embodiments, multiple scanning systems are used to evaluate the terrain through which the robot is about to travel in order to identify terrain variations, obstacles, other vehicles, road deviations, or any other significant environmental factors that could impact the stability of the robot.

On a coarse level, information regarding location of the robot is preferably obtained from a GPS device located on the body of the robot. In certain preferred embodiments, GPS-based information is used to ascertain the location of the robot with respect to the preplanned route and path.

Various perception systems are preferably employed by the present invention to assess terrain drivability, detect the presence of roads (if applicable), and detect the presence of obstacles. The data provided by these scanning processes are fused into a single map representation of the robots local environs. The map fusion process dramatically improves the robustness of the navigation system, as it enables the system to cope with sensor failures and missing data. To employ the data from the various sensor processing algorithms it is preferable to combine it into a composite world model, either implicitly or explicitly. In this system the data is combined in the sensor fusion module by generating a composite map using a weighted average of each of the input maps from the various sensor systems.

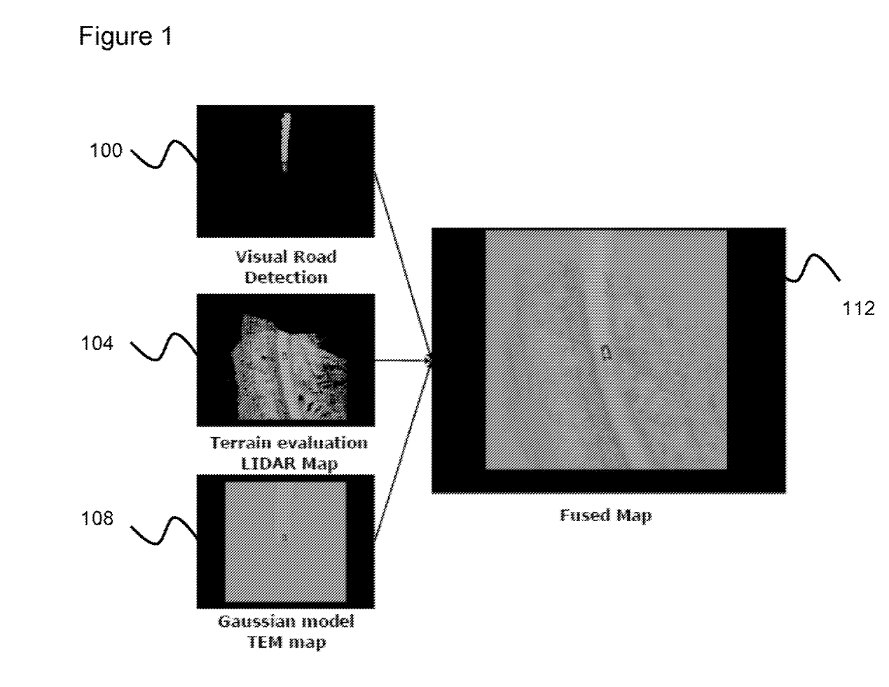

Each of the processing algorithms preferably specifies a confidence for the output map it generates. A fusion algorithm then combines the maps with these weightings to generate the composite expected cost map. The cost map evaluates the relative traversability of the upcoming environment. This design allows the sensor processing algorithms to adjust their contribution to the composite map if they recognize that they are performing poorly. In a presently preferred embodiment of the present invention a set of static weights, based on a heuristic sense of confidence in the algorithms ability to accurately assess the safety of terrain, is employed. With calibrated sensors, this approach produces usable composite terrain models. Some of those input maps are based on sensor detection of the road or terrain, while others are based on combinations of sensor information and mathematical models of sensor information. FIG. 1 shows various input maps 100, 104, 108 and the resulting fused composite map 112.

In the present approach to high-speed navigation, three principal risks are preferably considered—hitting big, obvious obstacles that can destroy a vehicle; driving on rough terrain that will damage a vehicle over prolonged periods of time; and loss of control due to dynamic effects such as sliding and roll-overs. The perception algorithms presented here are designed to address those goals. In the following description the sensory systems will be described with regards to an implementation that employs LIDAR and RADAR sensors. Those of skill in the art will recognize that there are multiple manners of implementing the scanning systems of the present invention. The Binary Obstacle LIDAR and RADAR processors of a presently preferred embodiment are designed to quickly detect obvious obstacles at range. The Terrain Evaluation LIDAR processor of a presently preferred embodiment is designed to generate a continuous classification of terrain, ranging from safe and smooth to intraversable. The slope calculations in this algorithm are preferably used to steer the robot away from terrain with a likelihood of causing static tip-over, but falls short of estimating dynamic tip-over. Instead, the risk from dynamic effects is mitigated in the speed planning algorithm.

The various perception algorithms preferably provide a set of models which overlap in location as well as capability. This overlap preferably reduces the likelihood of missing the detection of any obstacles and provides robustness in the face of a sensor or algorithmic failure.

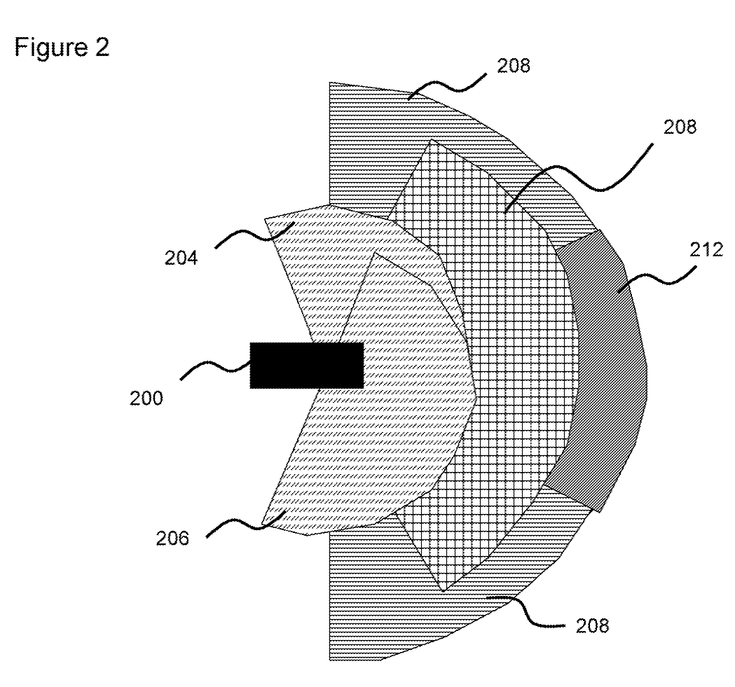

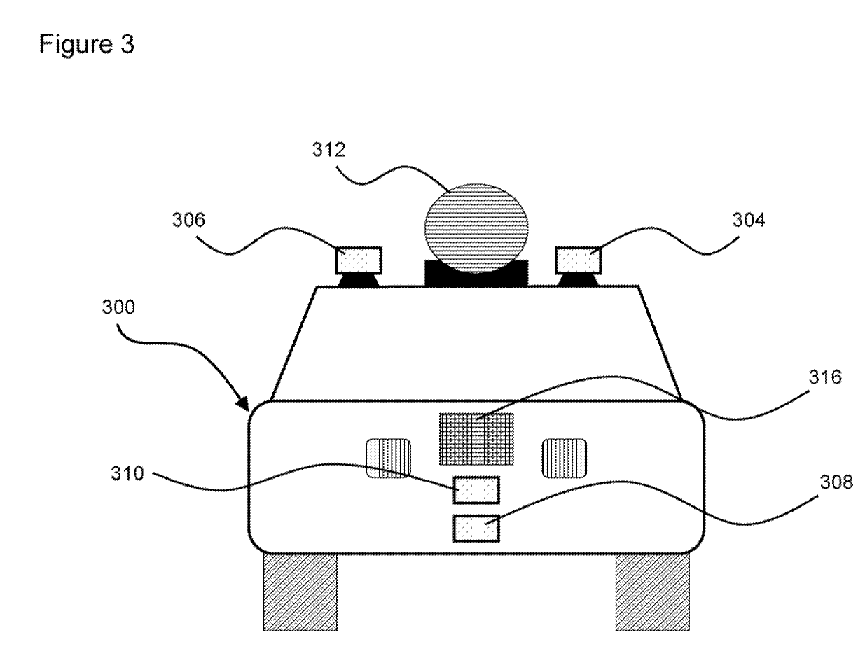

Presently preferred embodiments of the present invention combine data from a variety of sensors to perceive the world. In a particularly preferred embodiment, These considerations led to a perception strategy based on a set of five LIDAR and a navigation RADAR. Three of the LIDAR operate to characterize terrain, using overlapping field of view to provide redundancy. The two remaining LIDAR and the RADAR are used to detect obvious obstacles at long ranges. FIG. 2 illustrates the sensor fields of views for a presently preferred embodiment of the present invention while FIG. 3 shows the sensor locations on the robots in a presently preferred embodiment. The vehicle 200, 300 preferably has two shoulder-mounted LIDAR-based scanners 304, 306 with preferably overlapping fields of view shown as 204, 206 with a range of approximately 20 meters. The robots of the present invention also preferably include bumper-mounted LIDAR-based scanners 308, 310 with a range of approximately 40 meters and a field of view shown as 208. As discussed in greater detail below, presently preferred embodiments of the present invention also employ a gimbal-housed LIDAR-based scanner 312 with a range of approximately 50 meters and field of view shown as 212, though the field of view for the gimbal-housed LIDAR may be adjustable. Finally, presently preferred embodiments of the present invention include a RADAR-based scanner 316 with a field of view shown as 216. The present design provides a robust perception suite, with multiple sensors observing the significant portions of terrain in front of the robots.

In a presently preferred embodiment, a RIEGL Q140i scanning laser range finder 312 is used as the primary terrain perception sensor due to its long sensing range, ease of integration and few, well-understood failure modes. The present invention may also employ sensors that scan two axes at high speed (e.g., VELODYNE). The RIEGL LMS Q140i Airborne line-sensor used in the context of the present invention has a 60° field of view, a maximum sensing range of 150 m, a 12 kHz usable pixel rate, and a line-scan period of 20 ms (50 Hz).

In addition to the long range LIDAR, four SICK laser sensors may be used to provide short range supplemental sensing. Two are preferably mounted in the front bumper 308, 310, providing low, horizontal scans over a 180° wedge centered in front of the robot. These sensors may be used to detect obvious, large, positive obstacles. The other two SICK LMS laser sensors are preferably mounted to the left and right of the vehicle body 304, 306. These sensors preferably perform terrain classification. The SICK LMS provides a 180° field of view, an effective range of up to 50 m, a 13.5 kHz pixel rate, and a line scan period of 13.33 ms (75 Hz).

While LIDAR may have difficulties sensing in dusty environments, RADAR operates at a wavelength that penetrates dust and other visual obscurants but provides data that is more difficult to interpret. Because of its ability to sense through dust the NavTech DS2000 Continuous Wave Frequency Modulated (CWFM) radar scanner 316 is preferably used as a complimentary sensor to the LIDAR devices. The DSC2000 provides 360° scanning, 200 m range, 2.5 Hz scan rate, a 4° vertical beam width, and a 1.2° horizontal beam width.

Reliable and robust position sensing of the robot allows the present invention to perform reliable control and build usable world models. The implementation of position sensing is a major undertaking that can drain valuable development resources. To avoid this problem, the present invention preferably employs an off-the-shelf pose estimation system. In particularly preferred embodiments, the APPLANIX M-POS is used to provide position estimates by fusing inertial and differential GPS position estimates through a Kalman filter. The output estimate is specified to have sub-meter accuracies, even during extended periods of GPS dropout. The M-POS system also provides high accuracy angular information, through carrier differencing of the signal received by a pair of GPS antennas, and the inertial sensors. The M-POS system outputs a pose estimate over a high speed serial link at a rate of 100 Hz. This constant stream of low-latency pose information simplifies the task of integrating the various terrain sensor data sources.

Some embodiments of the present invention employ a sensor pointer. Preferably, the sensor pointer employs the pre-planned path as well as the specific navigation path as a guide as to where to orient at least some of the scanners. In some embodiments, the sensor pointer is used to point the RIEGL LIDAR. The sensor pointer enables a robot to point sensors around corners, prior to turning, and helps the perception system build detailed models of terrain in situations where the fixed sensors would generate limited information. A simple algorithm calculates a look-ahead point along the path given the current pose and speed of the robot. The look-ahead point is then used to calculate the pitch, roll and yaw in order to point the RIEGL at this location. These commands are then passed on to the gimbal. The data generated by the RIEGL and shoulder mounted SICK LIDAR scanners are preferably used by the terrain evaluation LIDAR processing algorithm.

Terrain classification and obstacle detection are at the core of high-speed outdoor navigation. In developing the terrain evaluation system of the present invention, the ideas of Kelly and others [P. Batavia, S. Singh, “Obstacle Detection in Smooth High Curvature Terrain,” Proceedings of the IEEE Conference on Robotics and Automation, May, 2002; A. Kelly & A. Stentz. “An Analysis of Requirements for Rough Terrain Autonomous Mobility”, Autonomous Robots, Vol. 4, No. 4, December, 1997; Kelly, A., et al., “Toward Reliable Off-Road Autonomous Vehicle Operating in Challenging Environments”, International Symposium on Experimental Robotics, June, 2004, Singapore] were employed in performing terrain evaluations within a single line scan. By processing individual scans, the present invention is able to reduce the effects of imperfect pose estimation when calculating terrainability. In addition to this algorithm, the robots of the present invention employ a second terrain evaluation method that uses data across a limited number of scans, which is described hereinbelow.

The terrain evaluation approach is derived from the Morphin algorithm [R. Simmons, E. Krotkov, L. Chrisman, F. Cozman, R. Goodwin, M. Hebert, L. Katragadda, S. Koenig, G. Krishnaswamy, Y. Shinoda, W. Whittaker, & P. Klarer. “Experience with Rover Navigation for Lunar-Like Terrains”, Proc. IEEE IROS, 1995; C. Urmson, M. Dias and R. Simmons, “Stereo Vision Based Navigation for Sun-Synchronous Exploration”, In Proceedings of the Conference on Intelligent Robots and Systems (IROS), Lausanne, Switzerland, September 2002] but has been adapted to operate on a single line scan of data instead of a complete cloud. The algorithm operates by fitting a line to the vertical planar projection of points spanning a vehicle width. The slope and chi-squared error over this neighborhood of points provide the basis for evaluation. This operation is performed at each LIDAR point in a scan. If the point does not have a minimum number of points or the surrounding points are not sufficiently dispersed, the point is not classified. The traversability cost is calculated as a weighted maximum of the slope and line fit residual.

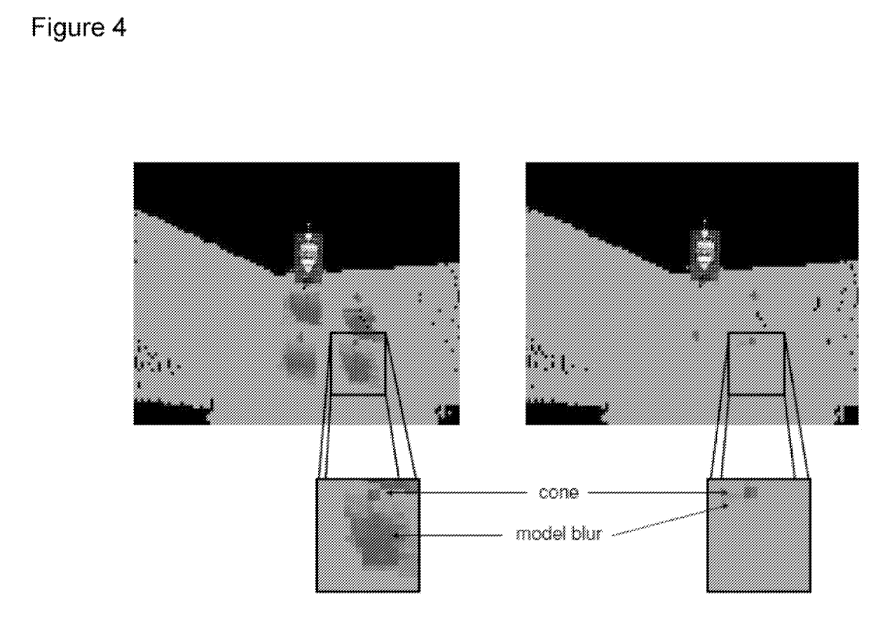

Once traversability costs have been evaluated, each point is projected into a cost map. Independent cost maps are preferably maintained for each sensor. See also description below of FIG. 7; 716, 722, 724. The terrain evaluation from each sensor is combined into a single output map. The traversability cost for each cell in the map is computed as the weighted average of the costs from each sensor, with the weights equal to the number of points used by that sensor in the evaluation of the cell. While this basic algorithm works well, it blurs small obstacles over a large area since it does not separate foreground objects from background terrain. FIG. 4 illustrates this problem.

To address this problem, a filter is preferably used to separate foreground features from background terrain. Any point at a significantly shorter range than the point being evaluated is ignored during the evaluation process. This has the effect of removing discrete foreground obstacles from the evaluation of background terrain, while still correctly detecting obstacles. FIG. 4 illustrates the effect of this filtering on a scene consisting of four cones in a diamond configuration. Without filtering, each of the four cones is represented as obstacles the size of a car, with the filtering applied the cones are represented as obstacles of the correct size.

Preferred embodiments of the present invention also employ sensors for obstacle detection. The present invention employs an algorithm that can quickly and robustly detect obstacles by collecting points over time while a vehicle drives over terrain. The algorithm uses geometric information to detect non-traversable terrain, exploiting the fact that LIDAR points tend to cluster on obstacles. As a LIDAR scan is moved through space, it sweeps the terrain and a point cloud representing this terrain is built by registering each scan with the vehicle and sensor pose. Within the context of the present invention, selected pairs of points from this cloud are compared to compute the slope and relative height of the terrain.

Traversability is determined by performing a point-wise comparison of points within a region surrounding the point in question. If the slope and vertical distance between the two points is determined to be greater than a threshold value, both points are classified as obstacles. Given two points to compare, slope is computed as:
θ=tan⁻¹(|Δz|,\sqrt{Δx²+Δy²})

If Δz and θ are greater threshold values, an obstacle is preferably inserted into the cost map.

Comparison of full rate LIDAR data is computationally expensive and is unattractive for high-speed navigation. To make comparison rates reasonable, points are preferably binned into 2D (x,y) cells and hashed by 2D cell location. Each hash location contains a list of all points within a cell. When a new point hashes to a hash location containing a list of points far from the new point, the list of points is preferably cleared and the new point is inserted. These data structure allow constant time comparison of nearby points by doing a hash lookup in the region of a point of interest.

With long range sensors, small errors in attitude of the sensor cause large errors in point registration. Comparison of two measurements of the same terrain patch from two different view points can falsely generate an obstacle if the vehicle pose is erroneously pitched or elevated. Because pose errors accumulate over time, it is important to delete points that are old and possibly inaccurate. To accommodate fast deletion, points are inserted into a ring buffer in the order that they are received. Once the ring buffer is full each new point overwrites the current oldest point in the buffer and the hash table.

Presently preferred embodiments of the present invention also employ RADAR sensing. RADAR sensing has several advantages for off-highway autonomous driving. It provides long range measurements and is not normally affected by dust, rain, smoke, or darkness. Unfortunately, it also provides little information about the world. Resolution on most small antennas is limited to 1 or 2 degrees in azimuth and 0.25 m in range. RADAR scanning is generally performed in 2D sweeps with a vertical beam height of <5 degrees. More narrowly focused beams are difficult to achieve and terrain height maps cannot be extracted from so wide a beam because objects of many heights are illuminated at the same time. This prevents using geometric or shape algorithms like those commonly used with LIDAR.

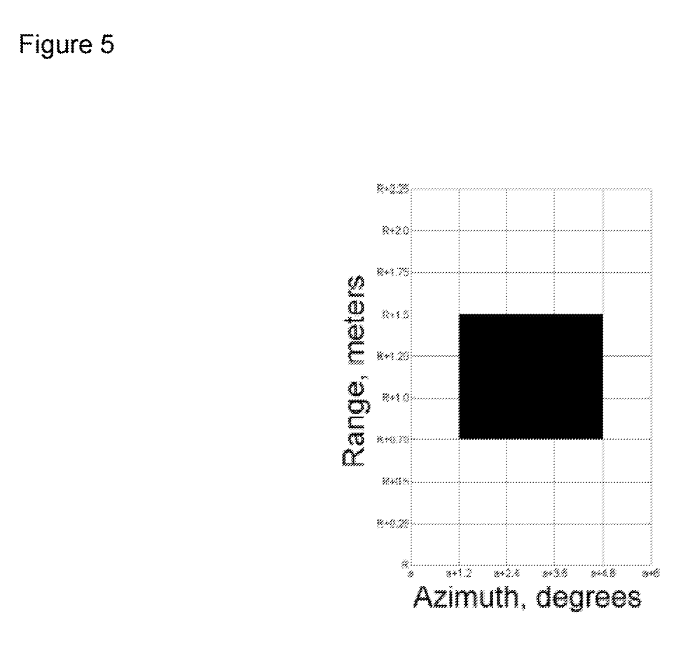

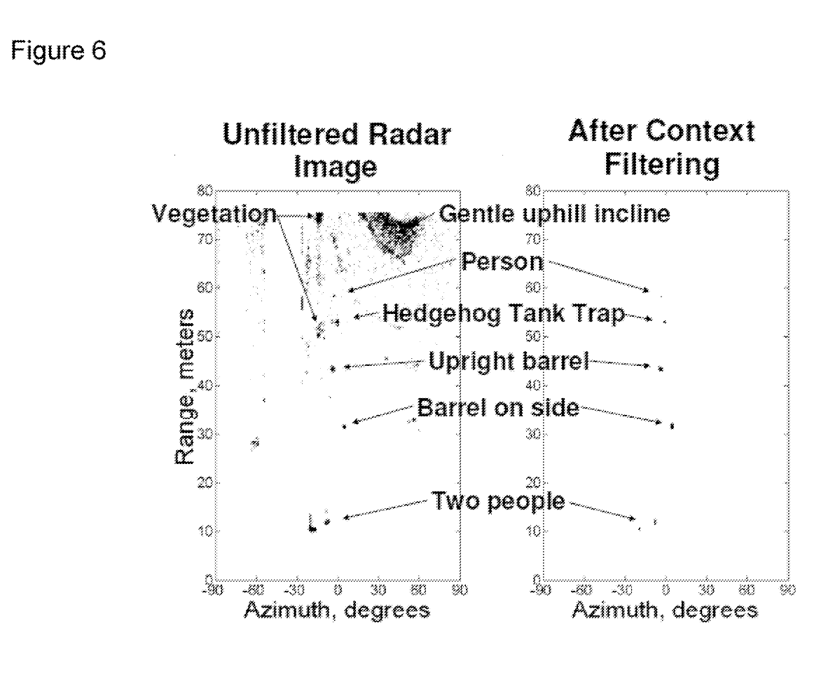

The primary challenge of processing radar data is separating dangerous or interesting objects from pervasive clutter. By employing the general rules that 1) vegetation, inclines, and rough road sections all produce backscatter distributed over a large area; and 2) obstacles like posts, cars, and telephone poles are generally isolated from one another, a binary object recognition algorithm for use with the present invention was generated. To implement an algorithm exploiting this classifier, radar data is organized into a 2 dimensional image consisting of range and azimuth bins (FIG. 5). A kernel consisting of two radii is convolved with this image. While the kernel is centered on a pixel, the energy between the inner and outer radii is subtracted from the energy contained within the inner radius. The value for this pixel is preferably compared to a threshold and then reported as obstacle or not. The strength of this filter is dictated by the ratio of negative to positive space, i.e. the ratio of the two radii. The size of the inner radius determines the footprint size for which the filter is tuned. Filtered and unfiltered scanning results from a desert scene from an implementation of the present invention are presented in FIG. 6. These algorithms allow the robot to identify objects within an environment. Such information is useful in the implementation of the navigational systems of the present invention.

The output of the sensors (i.e., object detection maps and the cost map) are preferably fused into a “fusion map” that allows the systems of the present invention to make determinations about paths rapidly and thus allow the robots of the present invention to navigate safely. To accomplish these tasks, navigation software located onboard the robots combines incoming sensor data with the preplanned path and speed to generate a new safe and traversable path.

A presently preferred overall structure of the navigation software of the present invention is shown in FIG. 7. The stars (“*”) shown in some elements of FIG. 7 indicate that robot pose information is preferably used by that element. The navigation architecture of the present invention 700 was designed with the infrastructure to support high-speed navigation while being robust to sensor failures and adaptable through a rapid, relatively unstructured development process. These design goals led to a path-centric navigation architecture, built around a set of well-defined, rigid data interfaces.

In the present path-centric architecture, the fundamental action of the robot is to follow a path. This approach differs from the majority of autonomous navigation architectures which use an arc as the basic action. The path-centric data structure is preferably pervasive throughout the present approach. The pre-planned route is preferably provided to the navigation system and planning operations act as filters on the path. The route is also used to steer sensor focus and allow the perception system to handle incompletely sensed terrain.

The path-centric architecture has several advantages that improve performance and robustness over arc-centric architectures. It provides a simple method for incorporating human input through a pre-planned route. It further reduces the search space for a planning algorithm from the square of the path length to linear in the path length, since planning is performed in a corridor around the pre-planned route. The path-centric approach avoids problems with arc-based arbitration such as discontinuities in steering commands (due to contradictory information) and jerky control (due to discrete arc-sets).

Returning to the general architecture for the navigation systems 700, the main components are shown in FIG. 7. As noted above, the present system preferably employs a pre-planned route, path, and speed 708 that has been build using risk assessment 704 of the environment to be traversed. The present invention preferably employs scanners to learn further about the environment, with a presently preferred combination of scanners 710, 712, 714 shown in FIG. 7. The present invention interprets that scanning information in light of robot pose to generate a cost analysis 716, and to perform binary object detection 718, 720, as described above. As also described above, information from binary object detection 718, 720 and cost analysis 716 is combined to form a fusion cost map 724 for use by the conformal planner 726 in developing a path for the robot to follow.

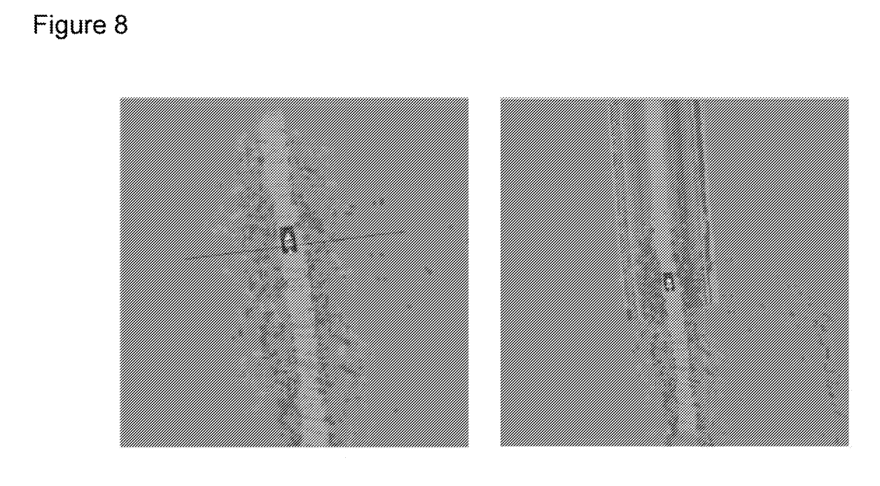

To use terrain evaluation data from multiple sources, the present architecture uses a map-based data fusion approach. To provide this functionality the architecture preferably defines a fundamental data type for the present system—the map. In the present system, a map is a rectilinear grid aligned with the world coordinate system and centered on the robot. Each of the sensor processing algorithms produces its output in the form of a cost map. As noted above, cost maps are a specific map type that represent the traversability of a cell with a numeric value. FIG. 8 displays two typical cost maps of the present invention.

To generate a cost map 724, the prescribed path is sampled regularly. At each of these sample points lines normal to the heading of the prescribed path are laid down. These normal lines are again sampled and the cost (from the other cost maps) is measured at these sample points. The average cost in the direction of the prescribed path at the normal line sample distances is computed and written into a new cost map 724. This map is fused with very low weight. During planning, the entire fused map 724 then has an estimate of the cost beyond the sensor horizon. The cost map 724 is also generated using information derived from binary object detection preferably performed by LIDAR-based 718 and RADAR-based 720 systems.

The prescribed path may have a consistent error due to misregistration or inaccuracy of the data used to generate the prescribed path, or due to errors in GPS-based localization. To improve stability of the trajectory of the robot, this consistent error can be inferred from the sensing data described above. There are several ways that the present invention may employ to infer this error. In the present embodiment of the present invention, the true location of the road is assumed to have a consistent bias laterally relative to the road. This bias is not typically directly estimated, but rather is inferred by generating an additional “Hallucinated” cost map 722 from the data in the other cost analyses 716 (FIG. 7). In some presently preferred embodiments, the location of a road is determined using sensor information and then an estimate of the offset and the shape of the road simultaneously is generated. Such an approach is particularly relevant to terrain that includes a well-defined road, such as urban settings.

The path and cost map are two of a handful of fundamental data types (other examples include vehicle pose and LIDAR line scan data structures) that are used as the syntax for communication between various data processing modules in the present invention. The software implementation uses a communication and infrastructural toolset that allows algorithm developers to create modules that communicate with the rest of the system using the specified data types through a set of abstract, reconfigurable interfaces. During development and debugging, the interfaces for an algorithm can be configured to read data from timetagged files using a common set of data access tools. As an algorithm matures, the interfaces are reconfigured to communicate with the rest of the navigation system.

By using a common set of carefully defined and strictly controlled data types as the syntax for communication, it is possible to quickly develop new features for either the path or map processing. While the syntax is defined and controlled, the semantics, or meaning, of the data being passed between modules is free to be adapted as new ideas evolve and algorithms are developed.

As noted above, the output from the sensors is transformed into a vehicle-centric map that includes information regarding obstacles, terrain, and robot pose. That fused map 724 is preferably provided to a conformal planner module 726 for the online planning of robot path. The planning portion of the online navigation system is preferably broken into a pair of modules that adjust the pre-planned path based on terrain cost evaluation generated by the perception algorithms 716. The first stage (the conformal planner 726) adjusts the path to avoid obstacles as identified in the cost map 724 and minimizes the cost of traversability of the terrain the robot will drive over. The speed planner 730 operates on the output of the conformal planner 726 and preemptively slows the robot for any sharp turns that may result when the conformal planner 726 generates a plan to avoid obstacles. Additionally, the speed planner 730 may take into account information from the route that is beyond the sensor field of view, such as speed limits and upcoming turns, to ensure that speeds are safe entering turns and dangerous areas.

The operation of the present navigational system 700 during navigation is here presented to further elaborate its operation. Trajectory planning algorithms attempt to find an optimal path from a starting point to a goal point. In general, the search space for a mobile robot is large, so search is computationally expensive. Deterministic searches typically discretize the search space at a resolution that allows fast search, but decreases efficiency and smoothness of solutions. Randomized algorithms may sample the search space in a continuous fashion and as a result quickly generate smooth paths, but tend to generate somewhat random trajectories.

In the context of the present invention, a prescribed route 708 consisting of a centerline with a set of bounds was considered as a starting point. The bounds and centerline did not exactly define a road, but instead kept vehicles near terrain that the vehicles were forced to traverse. This information was exploited by the present invention to significantly improve online planning speeds.

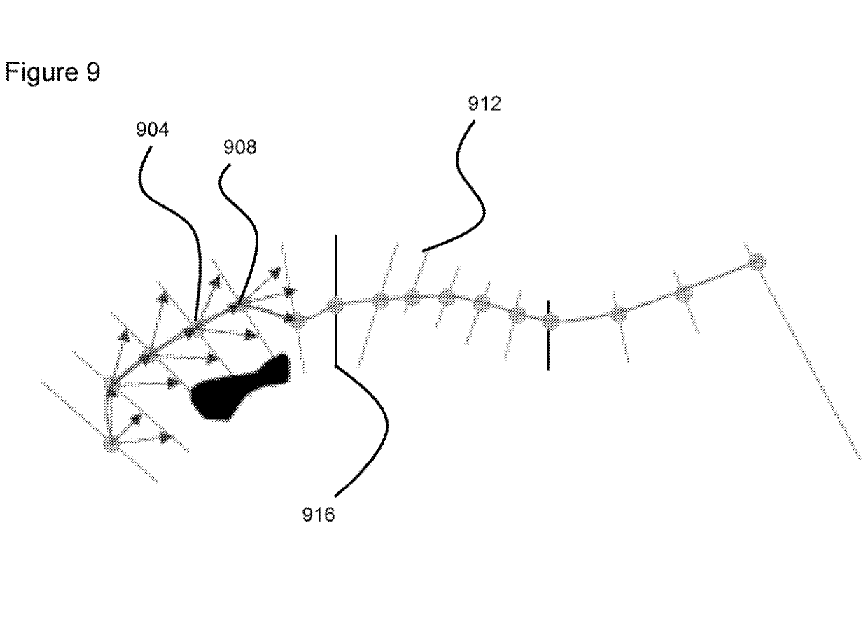

Because the route may be assumed to be somehow traversable, search by the sensors 710, 712, 714 may be limited to expansion near and in the direction of the path. A search graph is preferably constructed relative to the pre-planned path that conforms to the shape of the path and constrains the motion of the vehicle. The spacing of the graph along the path is varied to control stability as speed changes. The graph is searched using the commonly known A* algorithm and the nodes comprising the solution are connected by straight-line segments. Possible expansion nodes (e.g., 904, 908) are grouped in linear segments (e.g., 912, 916), oriented normal to the direction of travel of the path, similar to railroad ties FIG. 9. Nodes (e.g., 904, 908) are spread evenly across each of the segments (e.g., 912, 916). Each node is allowed to expand to neighboring nodes in the next segment. A node is considered to be a neighbor of another node if its lateral offset is within one step of the current node. Expansion opposing the direction of travel, or within a segment is disallowed within the software systems 700.

Cost at each node (e.g., 904, 908) is retrieved from the cost map 724 using an oriented rectangle roughly the size of the vehicle. The rectangle is centered on the node (e.g., 904, 908) and aligned with the direction of travel of the path. The rectangle is slightly larger than the size of the vehicle and costs beyond the extent of the vehicle are weighted less. That approach encourages the conformal planner 726 to avoid obstacles as identified by the binary object detection elements 718, 720 with a margin that accounts for error in tracking and sensing. Costs in the path-centric cost map 724 within the rectangle are averaged to produce a C-space expanded estimate of cost of traversability at that node. To encourage the conformal planner 726 to produce paths which are shaped like the pre-planned path 708, traversal cost to the left and right neighbors is increased by a factor square root of 2. In presently preferred embodiments, there is no penalty for departing from the pre-planned path 708. Instead, the pre-planned path 708 is used as an initial guide for the determination of the space to be searched. That information may be provided to a sensor pointer 734 which would in turn control the pointing of the gimbal 736 to collect relevant information regarding the portion of the environment most likely to be traversed. In other embodiments, a penalty is assessed for departing from the pre-planned path to attempt to force the robot back to the pre-planned path 708. However, in presently preferred embodiments, the robot will deviate freely from the pre-planned path 708 and choose the most appropriate path depending on the online-derived information regarding robot pose and local terrain and obstacle information 716, 718, 720, 724.

Each cycle, the cost map 724 is preferably regenerated and searched using A* to produce an optimal path given the most recent sensor data 710, 712, 714. The search starts from the closest point to the current vehicle location on the path to the last output by the conformal planner 726. A buffer with size proportional to the speed of the vehicle is added to this starting location to account for vehicle motion during the search.

The raw output path tends to have sharp turns—A* chooses to either go straight or avoid as hard as possible. These sharp turns slow the vehicle considerably, as the speed planner 730 attempts to slow the vehicle when sharp turns are approaching. In order to remove these sharp turns, a greedy smoothing operator is preferably applied to the path. The smoothing only occurs when the resulting smooth path has a cost similar to the original non-smooth path.

In most cases, the search operates quickly—greater than 20 Hz on the navigation computers. Occasionally, the search space is too complicated for the search to complete in a reasonable amount of time. Because the robot is a real-time system that may be traveling at high speed on rough terrain, planner lockup is unquestionably bad. To prevent lockup, the search times out after a 20^{th} of a second, returning the best path found at that point.

As vehicle 732 speed increases, dynamics become important. Speed induces side-slip and can cause rollover in vehicles with high a center of gravity. While obstacle avoidance and controller error can cause executed curvatures to be larger than the plan calls for, a rough idea of maximum vehicle speed can be determined in advance as a function of path curvature and maximum deceleration. The present invention may employ a variety of algorithms to model vehicle dynamics. Presently, a model that approximates a vehicle as a point mass with rigid wheels on a flat surface is preferred. The speed planning module of the present invention takes into account the model of the vehicle in planning speed so as to avoid side slip and rollover.

The onboard navigation system of the present invention 700 employs a modified conventional pure pursuit path tracking algorithm. As is common, the look-ahead distance is adjusted dynamically based on speed. The control gains are configured to provide a balance between good performance at both low speed in tight maneuvering situations, and at high speed on straight-aways and soft corners.

The basic pure pursuit algorithm works well if the output arcs are executed faithfully by the underlying vehicle controllers. Errors in the mapping between steering angle and curvature in the low level control scheme will induce systematic tracking errors. To correct for this problem, the basic pure-pursuit tracker is preferably augmented with an integral correction function. The error term is calculated as the lateral offset between the vehicle and the path, but only when the commanded steering angle is near zero curvature. This causes the integral term to accumulate on straight-aways, but not in corners where pure pursuit tracking would normally have significant errors. The scaled, integrated curvature correction term is then added to the desired curvature generated by the basic pure-pursuit algorithm before it is passed on to the vehicle control system.

After a path is determined by the conformal planner 726 and a speed is selected by the speed planner 730, the pure pursuit tracker 728 computes controls that are sent to the robot's 732 steering and acceleration systems using drive-by-wire technology.

After the navigation subsystem 700 establishes a desired path and velocity, that information is preferably transferred to hardware on the robot 732 that is capable of effecting those plans. In the case of autonomous vehicles, such implementations preferably include systems that control the speed and steering of the vehicle. In some embodiments, feedback controllers are used to regulate systems and position actuators. In many embodiments, a proportional integral derivative controller is employed to regulate systems.

The robots may also include power sources that can provide power to computers that are onboard the robots. In some implementations, the auxiliary power for computing is provided by a generator which may be powered separately from the engine. In other embodiments, a generator may be coupled to the engine via a belt. The power systems may be controlled by electronic control modules that contain embedded processors and input and output circuitry to monitor and control the power components. The generators may also provide power for any cooling that is necessary to maintain appropriate temperature for the computers that are onboard the robot.

Electronic actuation of steering is preferably employed for autonomous vehicle control. In presently preferred embodiments, the steering systems respond to steering curvature commands from a tracker in the navigation software. The commanded curvature may be linearly mapped to a steering angle in the controller, which is then maintained. In some embodiments, there is no feedback control around actual curvature, only around steering angle. In other embodiments, feedback control of actual curvature is employed. To electronically steer the wheels, a large, driven gear may be mounted to the top of the steering column, behind the steering wheel. A drive gear, attached to a DC motor and harmonic drive gear-set may then be mated with the steering column gear. The harmonic drive gearing provides a very high gear ratio with minimal backlash and large amounts of torque. The motor is controlled through a drive amplifier by an ECM, which may run a closed loop control algorithm around steering angle. Controller feedback may be provided by a rotational sensor mounted to the output shaft of the power-steering gearbox, which outputs a PWM signal proportional to steering position. For robustness, there may also be also a multi-turn sensor that measures position at the motor. A PID controller may be used to maintain wheel steering position by outputting motor torque and reading steering angle. This steering approach retains a majority of the stock steering system, which makes the system simple and robust.

In other embodiments, all of the stock steering components are removed and replaced with a full hydraulic steering system. The hydraulic system may be composed of a dual-cylinder rotary hydraulic actuator, a fixed displacement hydraulic pump, and an electro-hydraulic valve to control the hydraulic flow. Electronics in the valve maintain a closed-loop control of the valve's spool position. Spool position may be directly proportional to hydraulic flow (which can be mapped to cylinder velocity) and is commanded by an ECM. Steering angle is measured in the rotary actuator both by measuring the rotary output shaft position, and the linear position of one of the hydraulic cylinders. The ECM reads these positions, selects which one to use for feedback, and outputs a desired spool position based on a PID control algorithm. The advantage of this steering strategy is very responsive steering, and the ability to hold a very precise steering angle.

The present invention also provides for the control of vehicle velocity. Speed control is preferably accurate and responsive as it is routinely being adjusted to ensure vehicle stability. Navigation software preferably utilizes simple dynamic models in order to calculate safe speeds. Velocity also poses a controls challenge, since it involves two different mechanical systems (propulsion engine and brakes) to maintain speed in any number of environmental conditions.

In some embodiments, the robot has a mechanically controlled engine. This means that to actuate the throttle, a valve on the injection pump is physically turned. To accomplish this, an automotive-grade throttle body actuator may be modified and mounted to the injection pump. The actuator is a simple DC motor with analog position feedback. An ECM reads this position and runs a PID closed loop control algorithm in order to command the injection pump to a specific throttle level.

In other embodiments, the robot's engine may be fully electronically controlled, meaning that its entire operation, from fuel injection to timing is commanded by an electronic engine controller. This makes autonomous activation very simple; a message is sent across a data-link and acted on by the engine controller.

In presently preferred embodiments, stock service brakes are used to slow the vehicle. The service brakes are actuated by an electric motor. The motor may be three phase brushless design with an integral 50:1 harmonic drive gear reduction. In some embodiments, the motor is mounted to press on the brake pedal. This results in a relatively slow braking response but provides significant mechanical advantage. In other embodiments, the motor is mounted to actuate the brake master cylinder directly. This mounting achieves quicker response, since less motor travel accounts for more braking force. In both configurations ECM preferably runs a proportional controller to command braking, which effectively provides torque-based control of the motor. This type of control inherently compensates for system degradation such as brake wear or different pressure line losses.

Those of skill in the art will recognize that numerous modifications of the above-described methods and apparatuses can be performed without departing from the present invention. For example, one of skill in the art will recognize that the apparatuses of the present invention may be implemented using various hardware for scanning the area surrounding the vehicle.

We claim:

1. A method of autonomously navigating an environment by a robot, comprising the steps of:
collecting data about at least a portion of said environment using at least one sensor;
assessing said collected sensor data to identify obstacles within at least a portion of said environment;
assessing said collected sensor data to determine terrain roughness and terrain slope for at least a portion of said environment to establish a traversability rating for said portion of said environment;
generating a cost map of said environment incorporating said identified obstacles and said traversability rating;
planning a path through said environment using said cost map; and
traversing said environment.

2. The method of claim 1, wherein said at least one sensor is housed on said robot.

3. The method of claim 2, wherein said sensor is selected from the group consisting of RADAR-based sensor, LIDAR-based sensor, GPS-based sensor, and digital camera.

4. The method of claim 3, wherein said LIDAR-based sensor is housed in a gimbal.

5. The method of claim 4, wherein said gimbal is adapted to rotate and aim said LIDAR-based sensor.

6. The method of claim 3, wherein robot includes at least eight sensors.

7. The method of claim 6, wherein said five sensors include five LIDAR-based sensors, one RADAR-based sensor, one GPS-based sensor, and one digital camera.

8. The method of claim 2, wherein said at least one sensor is capable of being oriented.

9. The method of claim 8, wherein said at least one sensor is adapted to collect data about terrain directly in front of said robot.

10. The method of claim 1, further comprising estimating the pose of said robot.

11. The method of claim 10, wherein said pose of said robot includes information about robot orientation, location, and speed.

12. The method of claim 11, said pose of said robot is used to interpret said collected sensor data.

13. The method of claim 1, wherein said cost map is centered on said vehicle.

14. The method of claim 13, further comprising providing said cost map to a conformal planner.

15. The method of claim 14, wherein said conformal planner executes the planning of said path.

16. The method of claim 15, further comprising provide said path to a speed planner.

17. The method of claim 16, wherein said speed planner plans a speed for said robot.

18. The method of claim 17, further comprising a controlling step wherein said speed planner generates a series of commands to said robot to control said speed of said robot.

19. The method of claim 15, further comprising providing said path to a tracker.

20. The method of claim 19, further comprising a controlling step wherein said tracker employs said path to generate a series of commands to said robot to control said path of said robot.

21. The method of claim 20, wherein said series of commands includes steering commands.

22. The method of claim 15, wherein said conformal planner provides said path to a sensor pointer.

23. The method of claim 22, wherein said sensor pointer controls a gimbal.

24. The method of claim 23, wherein said gimbal houses a sensor.

25. The method of claim 24, wherein said sensor is a LIDAR-based sensor.

26. The method of claim 1, wherein said assessing said collected sensor data to identify obstacles step is accomplished by using at least one LIDAR-based sensor.

27. The method of claim 1, wherein said assessing said collected sensor data to identify obstacles step is accomplished by using at least one RADAR-based sensor.

28. The method of claim 1, wherein said assessing said collected sensor data to identify obstacles step is accomplished by using at least one LIDAR-based sensor and at least one RADAR-based sensor.

29. The method of claim 1, further comprising developing a pre-planned route, pre-planned path, and pre-planned speed prior to said robot being placed in said environment.

30. The method of claim 29, wherein said pre-planned route is generated using a series of waypoints.

31. The method of claim 30, wherein said waypoints are GPS coordinates.

32. The method of claim 29, wherein said pre-planned route defines said portion of said environment about which data is collected by said robot during said navigation.

33. The method of claim 30, further comprising interpolating said pre-planned path between said waypoints.

34. The method of claim 33, wherein said interpolating step employs splines.

35. The method of claim 34, wherein said splines are converted to tightly spaced waypoints.

36. The method of claim 35, wherein said tightly spaced waypoints are approximately 1 meter apart.

37. The method of claim 34, wherein a human modifies said splines.

38. The method of claim 29, wherein said planning of said pre-planned route, pre-planned path, and pre-planned speed includes estimating a risk of said environment.

39. The method of claim 38, wherein said estimating said risk includes information about terrain in said environment.

40. The method of claim 39, wherein said estimating said risk is performed by a human.

41. The method of claim 29, wherein said pre-planned route, pre-planned path, and pre-planned speed are used by said robot to orient said at least one sensor to collect information about at least a portion of said environment.

42. The method of claim 1, wherein said identifying is a binary process.

43. An apparatus for the autonomous navigation of an environment, comprising:
a chassis;
a plurality of sensors adapted to generate data about said environment;
an engine adapted to drive said apparatus;
a steering mechanism capable of steering said apparatus;
a gimbal, wherein said gimbal houses at least one of said plurality of sensors; and
at least one computer processor, wherein said computer processor is adapted to:
evaluate said sensor data to identify obstacles in said environment;
evaluate said sensor data to determine terrain roughness and terrain slope for at least a portion of said environment to establish a traversability rating for said portion of said environment; and
generate a cost map of said environment incorporating said identified obstacles and said traversability rating.

44. The apparatus of claim 43, wherein said plurality of sensors are selected from the group consisting of LIDAR-based sensor, RADAR-based sensor, GPS-based sensor, and digital camera.

45. The apparatus of claim 44, wherein said LIDAR-based sensor is a single-line scan LIDAR-based sensor.

46. The apparatus of claim 44, wherein said gimbal houses a LIDAR-based sensor.

47. The apparatus of claim 43, further comprising a brake controller.

48. The apparatus of claim 43, further comprising a throttle body controller, wherein said throttle body controller is adapted to control the state of the throttle.
